(19) United States
(12) Patent Application Publication
(10) Pub. No.: US 2025/0117912 A1
(43) Pub. Date: Apr. 10, 2025

(54) IMAGE PROCESSING APPARATUS

(71) Applicant: KYOCERA Document Solutions Inc., Osaka-shi (JP)

(72) Inventor: Hirotoshi Tagawa, Osaka (JP)

(21) Appl. No.: 18/906,896

(22) Filed: Oct. 4, 2024

(30) Foreign Application Priority Data
Oct. 6, 2023 (JP) 2023-174327

(51) Int. Cl. G06T 7/00; G06T 3/60; G06T 7/73; H04N 1/00; H04N 1/12

(52) U.S. Cl. CPC G06T 7/0002; G06T 3/60; G06T 7/73; H04N 1/00702; H04N 1/00718; H04N 1/00726; H04N 1/00734; H04N 1/1215; G06T 2207/30176

(57) ABSTRACT

An image processing apparatus includes an image sensor, a reference member, and a data processing portion. The reference member includes a white reference surface that opposes the image sensor via a conveying path. The data processing portion detects a reference dark image that falls below a reference light amount from reference image data expressing a detection light amount of the image sensor obtained when a sheet is not being conveyed. The data processing portion further detects a target dark image that falls below the reference light amount from data whose position in the main direction differs from a position of the reference dark image out of target image data expressing a detection light amount of the image sensor obtained when the sheet is being conveyed. Thus, the data processing portion detects a base end position corresponding to a tip end portion of the sheet in the target image data.

### INCORPORATION BY REFERENCE

This application is based upon and claims the benefit of priority from the corresponding Japanese Patent Application No. 2023-174327 filed on Oct. 6, 2023, the entire contents of which are incorporated herein by reference.

### BACKGROUND

The present disclosure relates to an image processing apparatus which detects a tip end of a sheet that is being conveyed by processing of image data expressing a detection light amount of an image sensor.

An image processing apparatus such as an image scanner, a copying machine, a facsimile apparatus, and a multifunction peripheral includes an image sensor arranged along a sheet conveying path. In addition, the image processing apparatus includes a reference member which includes a white reference surface that opposes the image sensor via the conveying path.

Further, the image processing apparatus is known to detect an image of a shadow generated along a tip end of a sheet that is being conveyed from image data expressing the detection light amount of the image sensor, to thus detect the tip end of the sheet.

### SUMMARY

An image processing apparatus according to an aspect of the present disclosure includes an image sensor, a reference member, and a data processing portion. The image sensor opposes a conveying path on which a sheet is conveyed and is arranged along a main direction that intersects with a sheet conveying direction. The reference member is arranged along the main direction and includes a white reference surface that opposes the image sensor via the conveying path. The data processing portion processes image data expressing a detection light amount of the image sensor. The data processing portion executes reference dark image detection processing for detecting a reference dark image that falls below a reference light amount from reference image data expressing a detection light amount of the image sensor obtained when the sheet is not being conveyed. The data processing portion further executes base end detection processing for detecting a target dark image that falls below the reference light amount from data whose position in the main direction differs from a position of the reference dark image out of target image data expressing a detection light amount of the image sensor obtained when the sheet is being conveyed after the reference dark image detection processing is executed, to thus detect a base end position corresponding to a tip end portion of the sheet in the target image data.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image processing apparatus according to a first embodiment;

FIG. 2 is a configuration diagram of image sensor units and reference members in the image processing apparatus according to the first embodiment;

FIG. 3 is a block diagram showing a configuration of a control device in the image processing apparatus according to the first embodiment;

FIG. 4 is a flowchart showing exemplary procedures of read image data processing in the image processing apparatus according to the first embodiment;

FIG. 5 is a diagram showing an example of a reference dark image that is detected from reference image data by the image processing apparatus according to the first embodiment;

FIG. 6 is a diagram showing an example of a target dark image that is detected from target image data by the image processing apparatus according to the first embodiment; and

FIG. 7 is a configuration diagram of an image processing apparatus according to a second embodiment.

### DETAILED DESCRIPTION

Hereinafter, embodiments of the present disclosure will be described with reference to the drawings. It is noted that the following embodiments are each an example of embodying the present disclosure and do not limit the technical scope of the present disclosure.

### First Embodiment: Configuration of Image Processing Apparatus 1

An image processing apparatus 1 according to a first embodiment is an image reading apparatus capable of conveying a document sheet 9 and reading an image from the document sheet 9 that is being conveyed. The document sheet 9 is a sheet on which an image is formed.

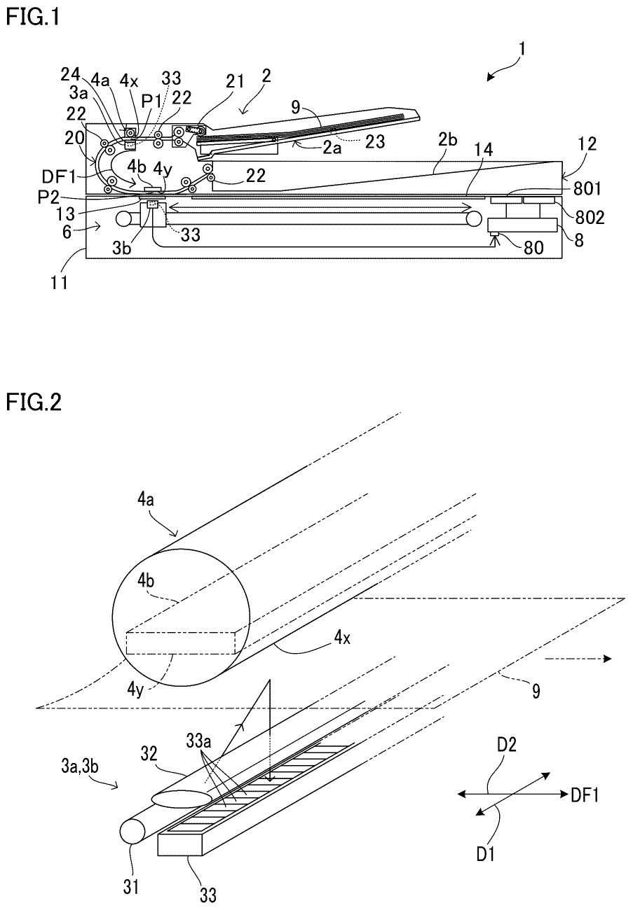

As shown in FIG. 1, the image processing apparatus 1 includes a body portion 11 and a cover portion 12 which covers an upper surface of the body portion 11. The body portion 11 is a housing which houses various devices.

The cover portion 12 is coupled to the body portion 11 and is supported while being displaceable between a close position at which it covers the upper surface of the body portion 11 and an open position at which it opens the upper surface of the body portion 11. In other words, the cover portion 12 is supported while being capable of opening and closing the upper surface of the body portion 11.

In addition, the image processing apparatus 1 includes contact glass 13 and platen glass 14 arranged on the upper surface of the body portion 11. The contact glass 13 and the platen glass 14 are each a transparent plate material.

In addition, the image processing apparatus 1 includes a document sheet conveying device 2, two image sensor units 3a and 3b, a sensor movement mechanism 6, a control device 8, an operation device 801, a display device 802, and the like. The document sheet conveying device 2 is incorporated in the cover portion 12.

The document sheet conveying device 2 includes a supply tray 2a, a discharge tray 2b, a conveying path 20, a feed mechanism 21, a plurality of conveying roller pairs 22, and the like. The document sheet conveying device 2 is incorporated in the cover portion 12. The document sheets 9 can be stacked on each of the supply tray 2a and the discharge tray 2b.

The conveying path 20 is a path on which the document sheet 9 is conveyed inside the cover portion 12. The conveying path 20 is provided from an entrance corresponding to the supply tray 2a to an exit corresponding to the discharge tray 2b via a first reading position P1 and a second reading position P2.

The feed mechanism 21 feeds the document sheets 9 stacked on the supply tray 2a one by one to the conveying path 20. The plurality of conveying roller pairs 22 rotate to convey the document sheet 9 along the conveying path 20. The last pair out of the plurality of conveying roller pairs 22 discharges the document sheet 9 onto the discharge tray 2b from the conveying path 20.

As described heretofore, the document sheet conveying device 2 conveys the document sheet 9 along the conveying path 20. The document sheet conveying device 2 is an example of a sheet conveying device which conveys the sheet along the conveying path 20.

The document sheet conveying device 2 further includes a document sheet sensor 23. The document sheet sensor 23 detects the document sheet 9 on the supply tray 2a. In other words, the document sheet sensor 23 is capable of detecting the presence/absence of the document sheet 9 on the supply tray 2a.

For example, the document sheet sensor 23 includes an actuator that is supported while being liftable and a photosensor which detects a movement of the actuator.

The actuator is retained at a protrusion position at which it protrudes from an upper surface of the supply tray 2a and is lowered from the protrusion position to an evacuation position by the weight of the document sheets 9. The photosensor detects the document sheet 9 on the supply tray 2a by detecting the lowering of the actuator to the evacuation position.

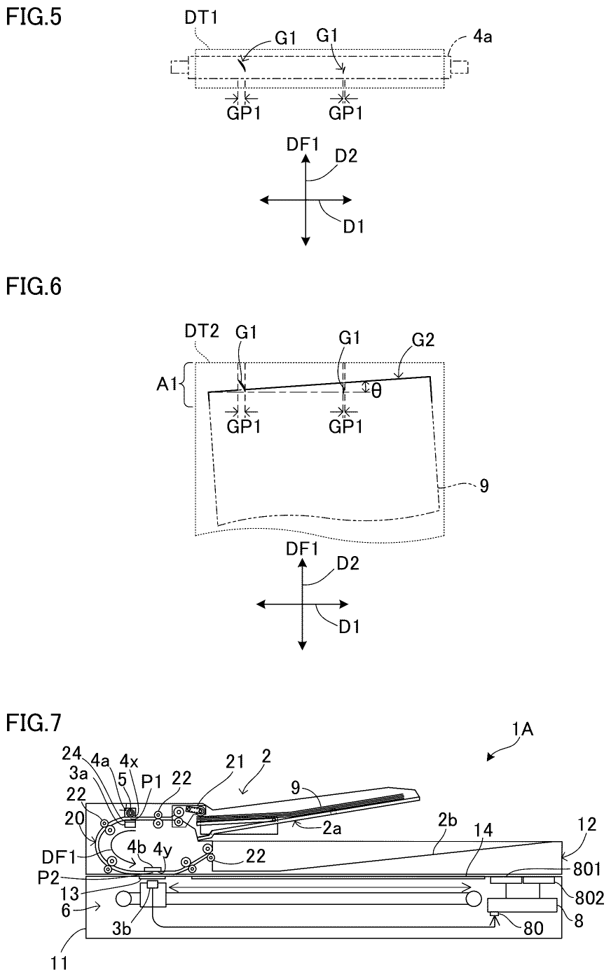

In FIG. 1, FIG. 2, FIG. 5, and FIG. 6, a conveying direction DF1 is a direction in which the document sheet 9 is conveyed along the conveying path 20. In other words, the conveying direction DF1 is a sheet conveying direction.

In FIG. 2, FIG. 5, and FIG. 6, a main direction D1 is a direction that intersects with the conveying direction DF1. In the present embodiment, the main direction D1 is a direction orthogonal to the conveying direction DF1.

The main direction D1 is a width direction of the document sheet 9 that is conveyed along the conveying path 20 and is a so-called main scanning direction. In FIG. 2, FIG. 5, and FIG. 6, a sub direction D2 is a direction along the conveying direction DF1. The sub direction D2 is a so-called sub-scanning direction.

The two image sensor units 3a and 3b include a first image sensor unit 3a and a second image sensor unit 3b. Each of the first image sensor unit 3a and the second image sensor unit 3b is arranged along the main direction D1.

That is, each of the first image sensor unit 3a and the second image sensor unit 3b is arranged in a state where a longitudinal direction thereof is provided along the main direction D1.

The first image sensor unit 3a is arranged opposed to the first reading position P1 on the conveying path 20 inside the cover portion 12. Contact glass 24 is arranged between the first image sensor unit 3a and the conveying path 20. The first image sensor unit 3a reads an image from a first surface of the document sheet 9 that passes through the first reading position P1.

The second image sensor unit 3b and the sensor movement mechanism 6 are arranged inside the body portion 11. The sensor movement mechanism 6 causes the second image sensor unit 3b to move along the contact glass 13 and the platen glass 14.

When the document sheet conveying device 2 conveys the document sheet 9, the sensor movement mechanism 6 retains the second image sensor unit 3b at a reference position. At the reference position, the second image sensor unit 3b opposes the second reading position P2 via the contact glass 13. The second image sensor unit 3b is retained in a state where a longitudinal direction thereof is provided along the main direction D1 by the sensor movement mechanism 6.

Further, when the document sheet 9 is placed on the platen glass 14, the sensor movement mechanism 6 causes the second image sensor unit 3b to move along the platen glass 14.

When retained at the reference position, the second image sensor unit 3b reads an image from a second surface of the document sheet 9 that passes through the second reading position P2.

In the present embodiment, a lower surface of the document sheet 9 placed on the supply tray 2a is the first surface, and an upper surface of the document sheet 9 placed on the supply tray 2a is the second surface.

Moreover, when moving along the platen glass 14, the second image sensor unit 3b reads an image from the lower surface of the document sheet 9 placed on the platen glass 14.

As shown in FIG. 2, each of the first image sensor unit 3a and the second image sensor unit 3b is a CIS (Contact Image Sensor) including a light-emitting portion 31, a lens 32, and an image sensor 33.

Each of the light-emitting portion 31, the lens 32, and the image sensor 33 is arranged in a state where a longitudinal direction thereof is provided along the main direction D1. Each of the light-emitting portion 31, the lens 32, and the image sensor 33 is arranged opposed to the conveying path 20.

The light-emitting portion 31 emits light toward the conveying path 20. The lens 32 collects reflected light of the light emitted from the light-emitting portion 31 to a light-receiving portion of the image sensor 33. The image sensor 33 is a line sensor that includes a plurality of photoelectric conversion elements 33a arrayed in the main direction D1. The image sensor 33 is a CMOS (Complementary Metal Oxide Semiconductor)-type sensor.

It is noted that in the second image sensor unit 3b, a CCD (Charge Coupled Device)-type image sensor may be adopted instead.

The image processing apparatus 1 further includes two reference members 4a and 4b (see FIG. 1 and FIG. 2). The two reference members 4a and 4b include a first reference member 4a and a second reference member 4b. In FIG. 2, the second reference member 4b and the document sheet 9 are indicated by virtual lines (dash-dot-dot lines).

Each of the first reference member 4a and the second reference member 4b is arranged along the main direction D1 (see FIG. 2). In other words, each of the first reference member 4a and the second reference member 4b is arranged in a state where a longitudinal direction thereof is provided along the main direction D1.

The first reference member 4a is arranged opposed to the first image sensor unit 3a via the conveying path 20. The first reference member 4a includes a white first reference surface 4x that opposes the image sensor 33 of the first image sensor unit 3a via the conveying path 20. The first reference surface 4x is arranged along the main direction D1.

In the present embodiment, the first reference member 4a is a roller member that rotates together with the plurality of conveying roller pairs 22. An outer circumferential surface of the roller member is the first reference surface 4x.

The second reference member 4b is arranged opposed to the second image sensor unit 3b retained at the reference position. The second reference member 4b includes a white second reference surface 4y that opposes the image sensor 33 of the second image sensor unit 3b via the conveying path 20. The second reference surface 4y is arranged along the main direction D1. In the present embodiment, the second reference member 4b is a plate-like member.

When the document sheet 9 is not conveyed, the first image sensor unit 3a reads the first reference surface 4x, and the second image sensor unit 3b reads the second reference surface 4y.

Each of the first image sensor unit 3a and the second image sensor unit 3b outputs image signals that express an image read from the document sheet 9. The image signals are converted into digital image data by an AFE (Analog Front End) 80, and the digital image data is transmitted to the control device 8.

The image data obtained via the first image sensor unit 3a expresses a detection light amount of the image sensor 33 in the first image sensor unit 3a. The image data obtained via the second image sensor unit 3b expresses a detection light amount of the image sensor 33 in the second image sensor unit 3b.

The operation device 801 is a device which accepts operations of people. For example, the operation device 801 includes operation buttons and a touch panel. The display device 802 is a device which displays information. For example, the display device 802 includes a panel display device such as a liquid crystal display unit.

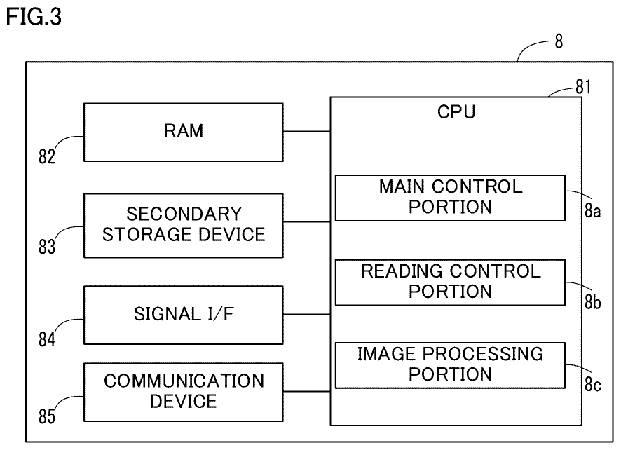

The control device 8 executes various types of data processing and control of the image processing apparatus 1. As shown in FIG. 3, the control device 8 includes a CPU (Central Processing Unit) 81, a RAM (Random Access Memory) 82, a secondary storage device 83, a signal interface 84, a communication device 85, and the like.

The secondary storage device 83 is a nonvolatile computer-readable storage device. The secondary storage device 83 is capable of storing and updating computer programs and various types of data. For example, one or both of a flash memory and a hard disk drive is/are adopted as the secondary storage device 83.

The signal interface 84 converts signals output from various sensors into digital data and transmits the digital data obtained by the conversion to the CPU 81. In addition, the signal interface 84 converts a control instruction output from the CPU 81 into control signals and transmits the control signals to a device to be controlled.

The CPU 81 is a processor which executes the computer programs to thus execute the various types data processing and control. The RAM 82 is a volatile computer-readable storage device. The RAM 82 primarily stores the computer programs to be executed by the CPU 81 and data to be output and referenced by the CPU 81 during a process of executing various types of processing.

The communication device 85 executes communication processing with other apparatuses via a network. The CPU 81 is capable of communicating with an information processing apparatus such as a personal computer via the communication device 85.

The CPU 81 includes a plurality of processing modules that are realized by executing the computer programs. The plurality of processing modules include a main control portion 8a, a reading control portion 8b, an image processing portion 8c, and the like.

The main control portion 8a executes control to start various types of processing according to operations with respect to the operation device 801, control of the display device 802, and the like.

For example, when a reading start operation is detected by the operation device 801 under a situation where the document sheet 9 is detected by the document sheet sensor 23, the main control portion 8a causes the reading control portion 8b to execute conveyance reading control.

Further, when the reading start operation is detected by the operation device 801 under a situation where the document sheet 9 is not detected by the document sheet sensor 23, the main control portion 8a causes the reading control portion 8b to execute table reading control.

The reading control portion 8b controls the document sheet conveying device 2 to control conveyance of the document sheet 9. In addition, the reading control portion 8b controls the sensor movement mechanism 6 to control the movement of the second image sensor unit 3b.

In addition, the reading control portion 8b causes the first image sensor unit 3a and the second image sensor unit 3b to execute reading processing. The reading processing is processing of reading an image from the document sheet 9.

In the conveyance reading control, the reading control portion 8b causes the sensor movement mechanism 6 to execute processing of retaining the second image sensor unit 3b at the reference position, and further causes the document sheet conveying device 2 to execute processing of conveying the document sheet 9.

Further, in the conveyance reading control, the reading control portion 8b causes the first image sensor unit 3a and the second image sensor unit 3b to execute the reading processing.

On the other hand, in the table reading control, the reading control portion 8b causes the sensor movement mechanism 6 to execute processing of moving the second image sensor unit 3b along the platen glass 14, and causes the second image sensor unit 3b to execute the reading processing.

The image processing portion 8c executes various types of data processing on the image data obtained via the image sensors 33 of the two image sensor units 3a and 3b when the reading processing is executed. The image processing portion 8c and the CPU 81 including the image processing portion 8c are each an example of a data processing portion which processes the image data.

As will be described later, the image processing portion 8c is capable of executing processing of detecting a tip end of the document sheet 9 that is being conveyed. The image processing portion 8c detects a tip end of the document sheet 9 by detecting an image of a shadow generated along the tip end of the document sheet 9 that is being conveyed from the image data obtained via each of the two image sensor units 3a and 3b.

Incidentally, the reference surfaces 4x and 4y of the reference members 4a and 4b, respectively, may get dirty. In this case, there is a fear that the image processing portion 8c will misperceive the smear on the reference surfaces 4x and 4y as the shadow generated along the tip end of the document sheet 9.

The image processing portion 8c executes read image data processing to be described later. The read image data processing includes processing for preventing the smear on the reference surfaces 4x and 4y respectively opposing the image sensor units 3a and 3b from adversely affecting the detection of the tip end of the document sheet 9.

### Read Image Data Processing

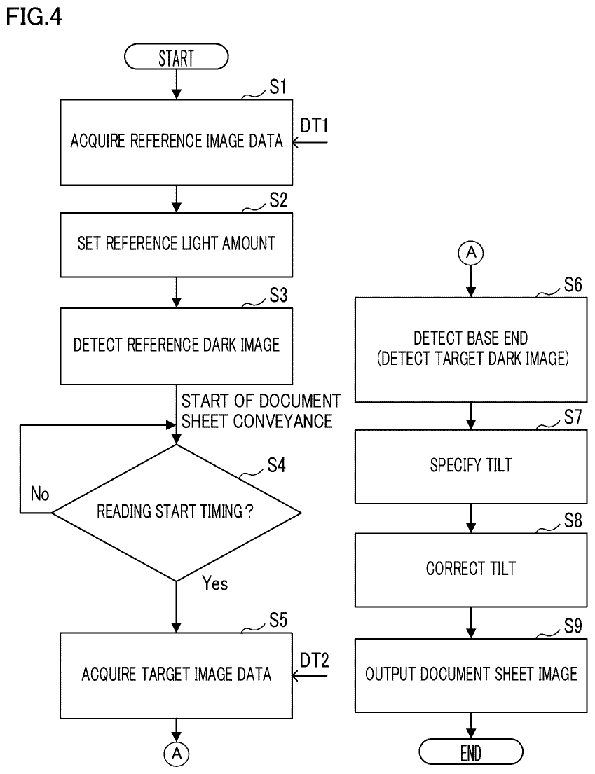

Hereinafter, exemplary procedures of the read image data processing will be described with reference to the flowchart shown in FIG. 4.

When the conveyance reading control is executed by the reading control portion 8b, the image processing portion 8c executes the read image data processing in parallel with the conveyance reading control.

In descriptions below, S1, S2, . . . represent identification codes of a plurality of steps in the read image data processing. In the read image data processing, processing of Step S1 is executed first.

The read image data processing is executed for the image data expressing the detection light amount of the image sensor 33 of each of the first image sensor unit 3a and the second image sensor unit 3b.

Hereinafter, the read image data processing related to the image data obtained via the image sensor 33 of the first image sensor unit 3a will be described first. The image data obtained via the image sensor 33 of the first image sensor unit 3a is data expressing the detection light amount of the image sensor 33 of the first image sensor unit 3a.

It is noted that differences between the read image data processing corresponding to the first image sensor unit 3a and the read image data processing corresponding to the second image sensor unit 3b will be described later.

### <Step S1>

In Step S1, the image processing portion 8c acquires reference image data DT1 which is the image data obtained via the image sensor 33 when the document sheet 9 is not being conveyed.

The image processing portion 8c acquires the reference image data DT1 from the image sensor 33 via the AFE 80. The reference image data DT1 is the image data expressing the detection light amount of the image sensor 33 regarding the reflected light on the first reference surface 4x.

In Step S1, an operation state of the document sheet conveying device 2 is a state where the plurality of conveying roller pairs 22 and the first reference member 4a are rotating and the feeding of the document sheet 9 by the feed mechanism 21 is not yet carried out.

In Step S1, the image processing portion 8c acquires the reference image data DT1 obtained via the image sensor 33 when the document sheet 9 is not conveyed and the first reference member 4a is rotating.

The image processing portion 8c acquires, as the reference image data DT1, the image data obtained via the image sensor 33 of the first image sensor unit 3a during a period in which the first reference member 4a rotates at least once.

After executing the processing of Step S1, the image processing portion 8c executes processing of Step S2.

### <Step S2>

In Step S2, the image processing portion 8c derives a representative value of data obtained at each position of the reference image data DT1 in the main direction D1, and sets a reference light amount for each position in the main direction D1 according to the representative value.

The reference light amount is a value used for detecting a shadow formed along the tip end of the document sheet 9.

For example, the image processing portion 8c derives, as the representative value obtained for each position in the main direction D1, a central value or average value of data obtained at each position of the reference image data DT1 in the main direction D1. Alternatively, the image processing portion 8c derives, as the representative value obtained for each position in the main direction D1, an average value of data that exceeds a predetermined lower limit light amount out of the data obtained at each position of the reference image data DT1 in the main direction D1.

For example, the image processing portion 8c sets, as the reference light amount obtained for each position in the main direction D1, a value obtained by multiplying the representative value obtained for each position in the main direction D1 by a predetermined coefficient.

The surface of the first reference surface 4x might be dirty by a relatively low concentration. By setting the reference light amount according to the representative value of the reference image data DT1, the reference light amount is set to a value with which the shadow generated at the tip end of the document sheet 9 and the smear on the surface of the first reference surface 4x can be distinguished from each other with more certainty.

After executing the processing of Step S2, the image processing portion 8c executes processing of Step S3.

### <Step S3>

In Step S3, the image processing portion 8c executes reference dark image detection processing that is based on the reference image data DT1.

The reference dark image detection processing is processing of detecting a reference dark image G1 that falls below the reference light amount from the reference image data DT1 (see FIG. 5). A relatively-dark smear on the surface of the first reference surface 4x is detected as the reference dark image G1 by the reference dark image detection processing.

When the reference dark image G1 is detected, the image processing portion 8c stores a reference dark image position GP1 that is a position of the reference dark image G1 in the main direction D1 (see FIG. 5).

After executing the processing of Step S3, the image processing portion 8c executes processing of Step S4. It is noted that before the processing of Step S4 is started since ending the processing of Step S1, the reading control portion 8b causes the document sheet conveying device 2 to start conveying the document sheet 9.

### <Step S4>

In Step S4, the image processing portion 8c stands by until a reading start timing arrives. The reading start timing is a timing at which an elapsed time since the start of the conveyance of the document sheet 9 reaches a first setting time.

The first setting time is a time required for the tip end of the document sheet 9 to reach a predetermined position on an upstream side of the conveying direction DF1 with respect to the first reading position P1 from the supply tray 2a.

When the reading start timing has arrived, the image processing portion 8c executes processing of Step S5.

### <Step S5>

In Step S5, the image processing portion 8c acquires target image data DT2 which is the image data obtained via the image sensor 33 during a period from the reading start timing to a reading end timing.

The reading end timing is a timing at which an elapsed time since the start of the conveyance of the document sheet 9 reaches a second setting time.

The second setting time is a time required for a rear end of the document sheet 9 to reach a predetermined position on a downstream side of the conveying direction DF1 with respect to the first reading position P1 from the supply tray 2a. In other words, the target image data DT2 is the image data obtained via the image sensor 33 when the document sheet 9 is being conveyed.

It is noted that the image processing portion 8c acquires size information that indicates a size of the document sheet 9 in advance. The image processing portion 8c specifies a document sheet length in the conveying direction DF1 based on the size information, and sets the second setting time based on the document sheet length.

The image processing portion 8c executes processing of Step S6 while acquiring the target image data DT2.

### <Step S6>

In Step S6, the image processing portion 8c executes base end detection processing that is based on the target image data DT2.

In the base end detection processing, the image processing portion 8c detects a target dark image G2 that falls below the reference light amount from data whose position in the main direction D1 differs from the reference dark image position GP1 out of the target image data DT2 (see FIG. 6). The target dark image G2 is an image of a shadow generated at an outer edge of a tip end portion of the document sheet 9 that is being conveyed.

For example, the image processing portion 8c detects the target dark image G2 from data whose position in the main direction D1 differs from the reference dark image position GP1 out of data of a predetermined head region A1 in the target image data DT2 (see FIG. 6).

By detecting the target dark image G2, the image processing portion 8c detects a base end position corresponding to the tip end portion of the document sheet 9. In other words, in the target image data DT2, the position of the target dark image G2 is the base end position corresponding to the position of the tip end portion of the document sheet 9.

Depending on the rotation position of the first reference member 4a when the document sheet 9 passes through the first reading position P1, the target image data DT2 may include the reference dark image G1 (see FIG. 6). In the base end detection processing, data including the reference dark image G1 is excluded from the detection target of the target image data DT2. Thus, the smear on the first reference surface 4x is prevented from adversely affecting the detection of the base end position.

After executing the processing of Step S6, the image processing portion 8c executes processing of Step S7.

### <Step S7>

In Step S7, the image processing portion 8c executes tilt specification processing. The tilt specification processing is processing of specifying a sheet tilt angle θ by specifying a tilt of the target dark image G2 in the longitudinal direction with respect to the main direction D1 (see FIG. 6).

The sheet tilt angle θ represents a tilt of the document sheet 9 that is being conveyed. An ideal conveying state of the document sheet 9 is a state where the sheet tilt angle θ is zero.

In general, the target dark image G2 is a continuous linear image formed across an entire width of the document sheet 9. However, since the data of the reference dark image position GP1 in the target image data DT2 is excluded from the detection target of the target dark image G2, a discontinuous linear image may be detected as the target dark image G2.

When the target dark image G2 is the discontinuous linear image, the image processing portion 8c corrects the target dark image G2 into a continuous linear image by linear interpolation. In addition, the image processing portion 8c specifies an angle formed between the corrected linear image and the main direction D1 as the sheet tilt angle θ.

After executing the processing of Step S7, the image processing portion 8c executes processing of Step S8.

### <Step S8>

In Step S8, the image processing portion 8c executes tilt correction processing. The tilt correction processing is processing of performing image rotation processing on the target image data DT2 according to the sheet tilt angle θ specified by the tilt specification processing.

After executing the processing of Step S8, the image processing portion 8c executes processing of Step S9.

### <Step S9>

In Step S9, the image processing portion 8c executes document sheet image output processing. The document sheet image output processing is processing of extracting, from the target image data DT2, document sheet image data while using the base end position as a reference, and outputting the document sheet image data. The document sheet image data is data expressing an image formed on the document sheet 9.

In the present embodiment, the image processing portion 8c extracts the document sheet image data from the target image data DT2 that has been subjected to the tilt correction processing.

For example, the image processing portion 8c extracts, from the target image data DT2, data of a region corresponding to the size information while using the base end position as a reference, and outputs the extracted data as the document sheet image data.

The image processing portion 8c outputs the document sheet image data to a predesignated output destination. The output destination is selected from the secondary storage device 83, an information processing apparatus that is communicable via the communication device 85, and the like.

After executing the processing of Step S9, the image processing portion 8c ends the read image data processing.

Next, different points between the read image data processing corresponding to the second image sensor unit 3b and the read image data processing corresponding to the first image sensor unit 3a will be described.

In Step S1, the image processing portion 8c acquires, as the reference image data DT1, the image data obtained by a plurality of times of reading processing performed by the image sensor 33 of the second image sensor unit 3b.

In Step S2, the image processing portion 8c derives, as the representative value, an average value of data obtained at each position of the reference image data DT1 in the main direction D1.

In Step S4, the first setting time corresponding to the reading start timing is a time required for the tip end of the document sheet 9 to reach a predetermined position on the upstream side of the conveying direction DF1 with respect to the second reading position P2 from the supply tray 2a.

The processing of the steps other than Step S1, Step S2, and Step S4 in the read image data processing is the same for the second image sensor unit 3b and the first image sensor unit 3a.

By executing the read image data processing, the smear on the reference surfaces 4x and 4y respectively opposing the image sensors 33 of the image sensor units 3a and 3b is prevented from adversely affecting the detection of the tip end of the document sheet 9.

### Second Embodiment: Image Processing Apparatus 1A

Next, an image processing apparatus 1A according to a second embodiment will be described with reference to FIG. 7.

The image processing apparatus 1A has a configuration in which a rotary encoder 5 is added to the image processing apparatus 1. The rotary encoder 5 detects a rotation position of the first reference member 4a. As described above, the first reference member 4a is the roller member that rotates. The white outer circumferential surface of the roller member is the first reference surface 4x.

Hereinafter, points of the read image data processing in the image processing apparatus 1A that are different from those of the read image data processing in the image processing apparatus 1 will be described.

In Step S1, the image processing portion 8c of the image processing apparatus 1A acquires the reference image data DT1 in association with a detection rotation position obtained by the rotary encoder 5. Thus, a plurality of pieces of pixel data configuring the reference image data DT1 are each associated with the position in the main direction D1 and the detection rotation position.

Further, in Step S3, the image processing portion 8c of the image processing apparatus 1A detects the reference dark image G1 in association with the detection rotation position. Thus, one or more pieces of pixel data configuring the reference dark image G1 are each associated with the position in the main direction D1 and the detection rotation position.

Further, in Step S5, the image processing portion 8c of the image processing apparatus 1A acquires the target image data DT2 in association with the detection rotation position. Thus, a plurality of pieces of pixel data configuring the target image data DT2 are each associated with the position in the main direction D1 and the detection rotation position.

Further, in Step S6, the image processing portion 8c of the image processing apparatus 1A detects the target dark image G2 using the positions of the reference dark images G1 respectively corresponding to the detection rotation positions.

In other words, the image processing portion 8c detects the target dark image G2 from data in which the position in the main direction D1 and the detection rotation position differ from the position of the reference dark image G1 out of the target image data DT2.

By adopting the image processing apparatus 1A, when an image of a shadow generated at the tip end portion of the document sheet 9 does not overlap with a smeared portion of the first reference surface 4x, the image of the shadow is detected as the target dark image G2 with more certainty.

Also when the image processing apparatus 1A is adopted, effects similar to those obtained when adopting the image processing apparatus 1 can be obtained.

### Modified Example

The image processing apparatuses 1 and 1A are the image reading apparatuses, but the first image sensor unit 3a, the first reference member 4a, and the processing of Step S1 to Step S7 of the read image data processing may be applied to an image forming apparatus such as a printer. The image forming apparatus is also an example of the image processing apparatus.

The image forming apparatus includes a sheet conveying device and a print device. The sheet conveying device conveys a sheet such as a paper sheet along a sheet conveying path. The print device forms an image on the sheet at a print position on the sheet conveying path.

The image forming apparatus includes a tilt correction device which corrects a tilt of the sheet at a position more on an upstream side of the sheet conveying direction than the print position on the sheet conveying path. In the image forming apparatus, the first image sensor unit 3a and the first reference member 4a are arranged on the upstream side of the sheet conveying direction with respect to the tilt correction device.

In the image forming apparatus, the tilt correction device corrects the tilt of the sheet according to the sheet tilt angle 0 specified by the tilt specification processing in Step S7. The sheet is conveyed to the print position after the tilt thereof is corrected by the tilt correction device.

Also when the present modified example is adopted, effects similar to those obtained when adopting the image processing apparatuses 1 and 1A can be obtained.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image processing apparatus, comprising:
an image sensor which opposes a conveying path on which a sheet is conveyed and is arranged along a main direction that intersects with a sheet conveying direction;
a reference member which is arranged along the main direction and includes a white reference surface that opposes the image sensor via the conveying path; and
a data processing portion which processes image data expressing a detection light amount of the image sensor, wherein
the data processing portion executes reference dark image detection processing for detecting a reference dark image that falls below a reference light amount from reference image data expressing a detection light amount of the image sensor obtained when the sheet is not being conveyed, and
the data processing portion further executes base end detection processing for detecting a target dark image that falls below the reference light amount from data whose position in the main direction differs from a position of the reference dark image out of target image data expressing a detection light amount of the image sensor obtained when the sheet is being conveyed after the reference dark image detection processing is executed, to thus detect a base end position corresponding to a tip end portion of the sheet in the target image data.

2. The image processing apparatus according to claim 1, wherein
the data processing portion executes document sheet image output processing for extracting, from the target image data, document sheet image data expressing an image formed on the sheet while using the base end position as a reference, and outputting the document sheet image data.

3. The image processing apparatus according to claim 1, wherein
the data processing portion executes tilt specification processing for specifying a tilt of the sheet that is being conveyed by specifying a tilt of the target dark image in a longitudinal direction with respect to the main direction.

4. The image processing apparatus according to claim 3, wherein
the data processing portion executes tilt correction processing for performing image rotation processing on the target image data according to the tilt specified by the tilt specification processing, and
the data processing portion further executes document sheet image output processing for extracting, from the target image data, document sheet image data expressing an image formed on the sheet while using the base end position as a reference, and outputting the document sheet image data.

5. The image processing apparatus according to claim 1, wherein
the reference member is a roller member which rotates and includes an outer circumferential surface constituting the reference surface, and
the data processing portion executes the reference dark image detection processing while using, as the reference image data, data expressing a detection light amount of the image sensor obtained during a period in which the roller member rotates at least once.

6. The image processing apparatus according to claim 5, further comprising:
a rotary encoder which detects a rotation position of the roller member, wherein
in the reference dark image detection processing, the data processing portion detects the reference dark image in association with a detection rotation position obtained by the rotary encoder, and
in the base end detection processing, the data processing portion further detects the target dark image using a position of the reference dark image corresponding to each of the detection rotation positions obtained by the rotary encoder.

7. The image processing apparatus according to claim 5, wherein
the data processing portion derives a representative value of data for each position in the main direction in the reference image data expressing the detection light amount of the image sensor obtained during the period in which the roller member rotates at least once, and sets the reference light amount for each position in the main direction according to the representative value.
